(19) United States
(12) Patent Application Publication
(10) Pub. No.: US 2009/0040891 A1
(43) Pub. Date: Feb. 12, 2009

(54) OPTICAL STORAGE DEVICE CAPABLE OF OPERATING WHEN ABNORMAL, AND RELATED METHOD

(76) Inventors: Wen-Fa Ting, Taipei County (TW); Te-Wang Tseng, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/053,626

(22) Filed: Mar. 24, 2008

(30) Foreign Application Priority Data
Aug. 6, 2007 (TW) 096128876

(51) Int. Cl. G11B 7/00

(52) U.S. Cl. 369/53.12

(57) ABSTRACT

An optical storage device capable of operating when abnormal, includes: a control unit for controlling operations of the optical storage device; and a sensor coupled to the control unit, where in a normal mode of the optical storage device, the control unit triggers the start-up or stop of a procedure through the sensor. The control unit is capable of controlling the optical storage device to enter an abnormal mode, and triggering the start-up or stop of the procedure in the abnormal mode according to whether the procedure times out or according to a user command.

### BACKGROUND

The present invention relates to an optical storage device, and more particularly, to optical storage devices capable of operating when abnormal and to related methods.

Regarding optical storage devices currently launched on the market, more particularly, optical disc players such as digital versatile disc (DVD) players, they can be roughly divided into desktop and portable types.

According to typical implementation methods, it is required for a manufacturer to install a motor within a desktop optical disc player in order to drive a tray, and to further utilize two sensors for detecting whether the tray is in a tray in state or a tray out state. In the tray out state, the desktop optical disc player may wait for an optical disc put by a user. In addition, in the tray in state, the desktop optical disc player may read data of the optical disc. According to the related art, in order to save costs, most of manufacturers implement the sensors mentioned above by mechanical limit switches, and implement the tray mentioned above and contact mechanisms within the tray by plastic materials, where the contact mechanisms are utilized for pressing the sensors. Thus, the sensors tend to rust while aging, and the contact mechanisms tend to fracture because of improper vibration and drop. Once the sensors or the contact mechanisms are damaged, operations of the sensors will be abnormal. The same problem may occur in optical disc drives that are utilized as computer peripherals/accessories, for example, DVD drives.

In addition, according to typical implementation methods, it is required for a manufacturer to install a lid within a portable optical disc player, where the lid is utilized for covering an optical disc loading area. The portable optical disc player utilizes a sensor to detect whether the lid is in a lid-open state or in a lid-closed state. In the lid-open state, the portable optical disc player may wait for an optical disc put by a user. In the lid-closed state, the portable optical disc player may read data of the optical disc. Similarly, in order to save costs, most of manufacturers implement the sensors by mechanical limit switches, and implement at least a portion of the tray and contact mechanisms within the lid by plastic materials, where the contact mechanisms are utilized for pressing the sensors. Once the sensors or the contact mechanisms are damaged, operations of the sensors will be abnormal.

As mentioned above, no matter which type of optical storage devices are considered, if the manufacturers have not properly controlled the workflows of the optical storage devices, once the sensors or the contact mechanisms mentioned above are damaged, the malfunction may irritate the users, causing the products to be sent back for repair or for replacement with a new one due to some warranty conditions. Thus, the operation costs of the manufacturers are increased.

Regarding the problems mentioned above, the related art merely focuses on enhancement of the contact mechanisms in a design phase. Regarding abnormal operations due to abnormal sensors or damaged contact mechanisms, however, the related art lacks for an essential protection solution or backup solution for being applied to the workflows of the optical storage devices in the abnormal situations mentioned above.

### SUMMARY

It is therefore an objective of the claimed invention to provide optical storage devices capable of operating when abnormal and to provide related methods, in order to solve the above-mentioned problems.

It is therefore an objective of the claimed invention to provide optical storage devices capable of operating when abnormal and to provide related methods, in order to provide protection solutions or backup solutions for being applied to workflows of optical storage devices in abnormal situations.

An exemplary embodiment of an optical storage device capable of operating when abnormal comprises a control unit and a sensor coupled to the control unit. The control unit is utilized for controlling operations of the optical storage device. In addition, in a normal mode of the optical storage device, the control unit triggers the start-up or stop of a procedure through the sensor. Additionally, the control unit is capable of controlling the optical storage device to enter an abnormal mode, and triggering the start-up or stop of the procedure in the abnormal mode according to whether the procedure times out or according to a user command.

An exemplary embodiment of a method for controlling an optical storage device to be capable of operating when abnormal comprises: in a normal mode of the optical storage device, triggering the start-up or stop of a procedure through a sensor of the optical storage device; and selectively controlling the optical storage device to enter an abnormal mode, and triggering the start-up or stop of the procedure in the abnormal mode according to whether the procedure times out or according to a user command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical storage device capable of operating when abnormal according to a first embodiment of the present invention.

FIG. 2 is a flowchart of a method for controlling an optical storage device to be capable of operating when abnormal according to one embodiment of the present invention.

FIG. 3 is a flowchart of a method for controlling an optical storage device to be capable of operating when abnormal according to another embodiment of the present invention.

FIG. 4 is a diagram of an optical storage device capable of operating when abnormal according to a second embodiment of the present invention.

FIG. 5 is a flowchart of a method for controlling an optical storage device to be capable of operating when abnormal according to one embodiment of the present invention.

FIG. 6 is a flowchart of a method for controlling an optical storage device to be capable of operating when abnormal according to another embodiment of the present invention.

### DETAILED DESCRIPTION

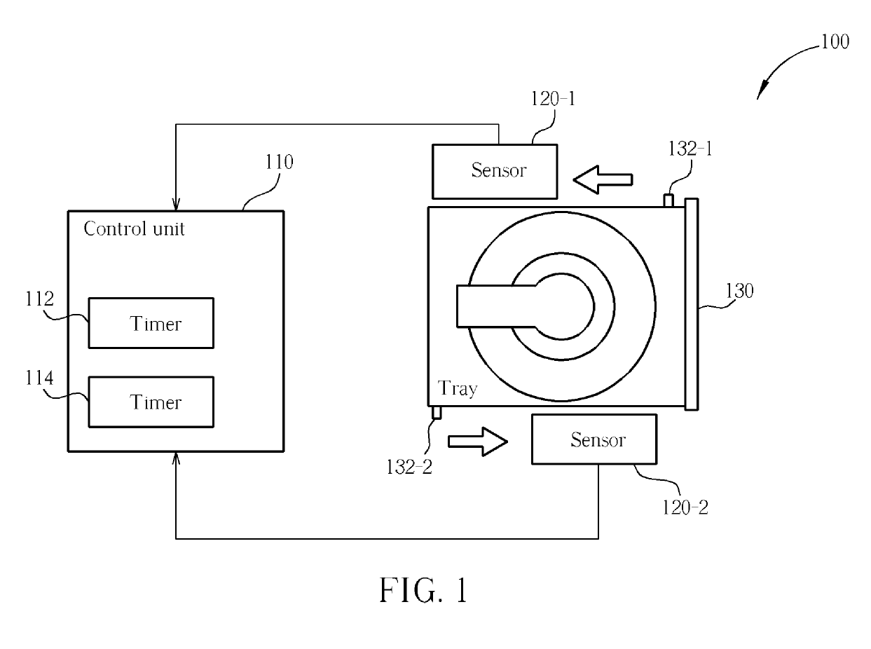

Please refer to FIG. 1. FIG. 1 is a diagram of an optical storage device 100 capable of operating when abnormal according to a first embodiment of the present invention, where the optical storage device 100 comprises a control unit 110, a plurality of sensors 120-1 and 120-2, and a tray 130, and the control unit 110 comprises a plurality of timers 112 and 114, and the tray 130 comprises a plurality of contact mechanisms 132-1 and 132-2, respectively corresponding to the sensors 120-1 and 120-2. According to one application of this embodiment, the optical storage device 100 can be an optical disc player such as a digital versatile disc (DVD) player. According to another application of this embodiment, the optical storage device 100 can be an optical disc drive applied to computer peripherals/accessories, for example, a DVD drive.

According to this embodiment, the control unit 110 is a micro processing unit (MPU) executing a firmware code, and is utilized for controlling operations of the optical storage device 100, where the timers 112 and 114 can be utilized for detecting whether a procedure times out. For example, the procedure can be a tray in procedure or a tray out procedure. In addition, the sensors 120-1 and 120-2 may be limit switches, and are utilized for triggering the start-up or stop of the procedure. More particularly, in this embodiment, the sensor 120-1 is utilized for triggering the stop of the tray in procedure, and the sensor 120-2 is utilized for triggering the stop of the tray out procedure. Additionally, the tray 130 can be utilized for loading an optical disc.

According to this embodiment, if the aforementioned sensors (which are limit switches here) and the tray 130 are not damaged and operate normally, in a normal mode of the optical storage device 100, once the tray 130 contacts/presses a certain sensor corresponding to a certain procedure (e.g. the sensors 120-1 or 120-2), the sensor triggers the stop of the procedure. For example, once the contact mechanism 132-1 of the tray 130 contacts/presses the sensor 120-1 corresponding to the tray in procedure, the sensor 120-1 triggers the stop of the tray in procedure. In another example, once the contact mechanism 132-2 of the tray 130 contacts/presses the sensor 120-2 corresponding to the tray out procedure, the sensor 120-2 triggers the stop of the tray out procedure.

In addition, the control unit 110 is capable of controlling the optical storage device 100 to enter an abnormal mode, and triggering the start-up or stop of the procedure in the abnormal mode according to whether the procedure times out or according to a user command. More particularly, in this embodiment, the control unit 110 triggers the stop of the procedure in the abnormal mode according to whether the procedure times out.

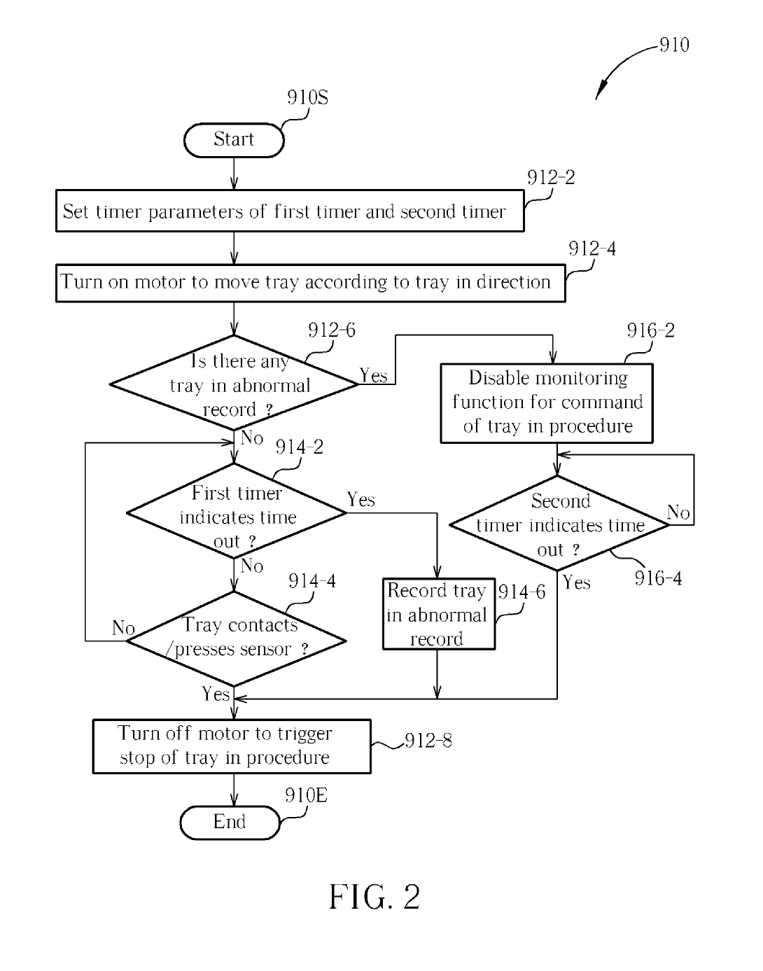

Please refer to FIG. 2. FIG. 2 is a flowchart of a method 910 for controlling an optical storage device to be capable of operating when abnormal according to one embodiment of the present invention, where the method 910 can be applied to the embodiment shown in FIG. 1, and described as follows.

In this embodiment, the method 910 represents a workflow of the tray in procedure, where the Steps 914-2, 914-4, and 914-6 correspond to the normal mode, and the Steps 916-2 and 916-4 correspond to the abnormal mode.

In Step 912-2, the control unit 110 sets timer parameters of the timers 112 and 114. The timers 112 and 114 of this embodiment are both countdown timers, where once one of the timers counts down to 0, means the object being timed (i.e. one of the procedures here) times out. In addition, the control unit 110 sets a timer parameter Timer2 as an initial value of the timer 112, and sets a timer parameter Timer3 as an initial value of the timer 114. According to this embodiment, Timer2=3 seconds, and Timer3=2 seconds.

In Step 912-4, the control unit 110 turns on a motor of the optical storage device 100 to move the tray 130 according to a tray in direction.

In Step 912-6, the control unit 110 checks whether there is any tray in abnormal record. As the optical storage device 100 can not leave the factory before passing all tests, when the optical storage device 100 is used by a user, Step 914-2 will be entered after Step 912-6 is first executed.

In Step 914-2, the control unit 110 checks whether the timer 112 indicates that the tray in procedure times out. If the tray in procedure times out, enter Step 914-6; otherwise, enter Step 914-4.

In Step 914-4, the control unit 110 checks whether the tray 130 contacts/presses the sensor 120-1. If it is detected that the tray 130 contacts/presses the sensor 120-1, enter Step 912-8; otherwise, re-enter Step 914-2.

In Step 914-6, the control unit 110 records a tray in abnormal record. Thus, when the optical storage device 100 performs the tray in procedure next time, once the control unit 110 executes Step 912-6, Step 916-2 would then be entered in order to control the optical storage device 100 to enter the abnormal mode.

In Step 916-2, the control unit 110 disables a monitoring function for a command of the tray in procedure. In this embodiment, the command may represent a command triggered by a button of the optical storage device 100, or an infrared (IR) remote control command, where the later can be referred to as the IR command.

In Step 916-4, the control unit 110 checks whether the timer 114 indicates that the tray in procedure times out. If the tray in procedure times out, enter Step 912-8 to trigger the stop of the tray in procedure; otherwise, re-enter Step 916-4 to keep waiting.

According to this embodiment, if both the sensor 120-1 (which is a limit switch here) and the tray 130 are not damaged and operate normally, in the normal mode, the tray 130 triggers the stop of the tray in procedure according to whether the tray 130 contacts/presses the sensor 120-1. In addition, once the sensor 120-1 or the contact mechanism 132-1 of the tray 130 is damaged, the optical storage device 100 is still capable of triggering the stop of the tray in procedure according to the workflow shown in FIG. 2, and entering the abnormal mode for making up by itself when executing the tray in procedure next time. Thus, the embodiment of this invention provides a protection solution that have not been applied to any product launched on the market, so that in the situation the sensor 120-1 or the tray 130 is damaged and operates abnormally, the user may use the optical storage device 100 as usual without interrupting his/her work and life, so the user will not be forced to cancel his/her important appointments/schedules on the to-do list because of urgent repair of the optical storage device 100. As a result, this invention improves the user's convenience and decision-making power of his/her own time in the situation mentioned above.

As mentioned in this embodiment, the control unit 110 utilizes different timer parameters Time2 and Time3 to detect whether the tray in procedure times out in the normal mode and whether the tray in procedure times out in the abnormal mode, respectively. According to a variation of this embodiment, the control unit 110 utilizes the same timer parameter Time2′ to respectively detect whether the tray in procedure times out in the normal and whether the tray in procedure times out in the abnormal mode, respectively. Here, Time2′=2.5 seconds.

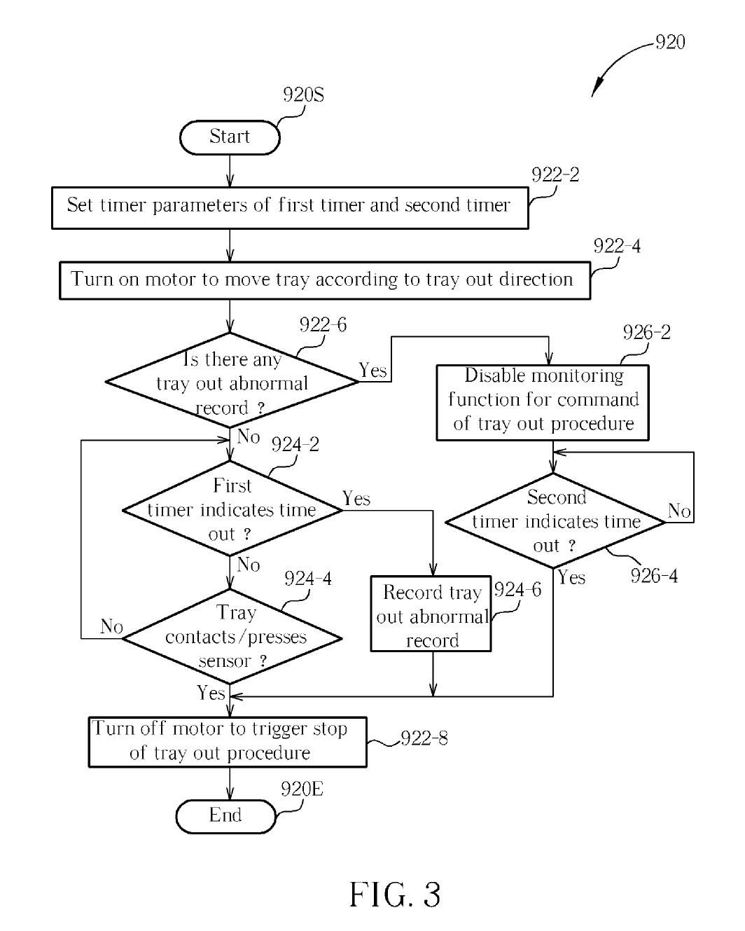

FIG. 3 is a flowchart of a method 920 for controlling an optical storage device to be capable of operating when abnormal according to another embodiment of the present invention, where the method 920 is also capable of being applied to the embodiment shown in FIG. 1, and described as follows.

In this embodiment, the method 920 represents a workflow of the tray out procedure, where Steps 924-2, 924-4 and 924-6 correspond to the normal mode and Steps 926-2 and 926-4 correspond to the abnormal mode.

In Step 922-2, the control unit 110 sets timer parameters of the timers 112 and 114. The timers 112 and 114 of this embodiment are both countdown timers. In addition, the control unit 110 sets a timer parameter Timer0 as an initial value of the timer 112, and sets a timer parameter Timer1 as an initial value of the timer 114. According to this embodiment, Timer0=3 seconds, and Timer1=2 seconds.

In Step 922-4, the control unit 110 turns on a motor of the optical storage device 100 to move the tray 130 according to a tray out direction. In this embodiment, the optical storage device 100 utilizes the same motor as that for the tray in procedure, where the movement of the tray 130 is implemented with an inverse operation of the motor.

In Step 922-6, the control unit 110 checks whether there is any tray out abnormal record. As the optical storage device 100 can not leave the factory before passing all tests, when the optical storage device 100 is used by a user, Step 924-2 will be entered after Step 922-6 is first executed.

In Step 924-2, the control unit 110 checks whether the timer 112 indicates that the tray out procedure times out. If the tray out procedure times out, enter Step 924-6; otherwise, enter Step 924-4.

In Step 924-4, the control unit 110 checks whether the tray 130 contacts/presses the sensor 120-2. If it is detected that the tray 130 contacts/presses the sensor 120-2, enter Step 922-8; otherwise, re-enter Step 924-2.

In Step 924-6, the control unit 110 records a tray out abnormal record. Thus, when the optical storage device 100 performs the tray out procedure next time, once the control unit 110 executes Step 922-6, Step 926-2 would then be entered in order to control the optical storage device 100 to enter the abnormal mode.

In Step 926-2, the control unit 110 disables a monitoring function for a command of the tray out procedure. In this embodiment, the command may represent a command triggered by a button of the optical storage device 100, or an IR remote control command.

In Step 926-4, the control unit 110 checks whether the timer 114 indicates that the tray out procedure times out. If the tray out procedure times out, enter Step 922-8; otherwise, re-enter Step 926-4 to keep waiting.

According to this embodiment, if both the sensor 120-2 (which is a limit switch here) and the tray 130 are not damaged and operate normally, in the normal mode, the tray 130 triggers the stop of the tray out procedure according to whether the tray 130 contacts/presses the sensor 120-2. Additionally, once the sensor 120-2 or the contact mechanism 132-2 of the tray 130 is damaged, the optical storage device 100 is still capable of triggering the stop of the tray out procedure according to the workflow shown in FIG. 3, and entering the abnormal mode for making up by itself when executing the tray out procedure next time. Thus, the embodiment of this invention provides a protection solution that have not been applied to any product launched on the market, so that in the situation when the sensor 120-2 or the tray 130 is damaged and operates abnormally, the user may use the optical storage device 100 as usual without interrupting his/her work and life, so the user will not be forced to cancel his/her important appointments/schedules on the to-do list because of urgent repair of the optical storage device 100. As a result, this invention improves the user's convenience and decision-making power of his/her own time in the situation mentioned above.

As mentioned in this embodiment, the control unit 110 utilizes different timer parameters Time0 and Time1 to detect whether the tray out procedure times out in the normal mode and whether the tray out procedure times out in the abnormal mode, respectively. According to a variation of this embodiment, the control unit 110 utilizes the same timer parameter Time0′ to detect whether the tray out procedure times out in the normal mode and whether the tray out procedure times out in the abnormal mode, respectively. Here, Time0′=2.5 seconds.

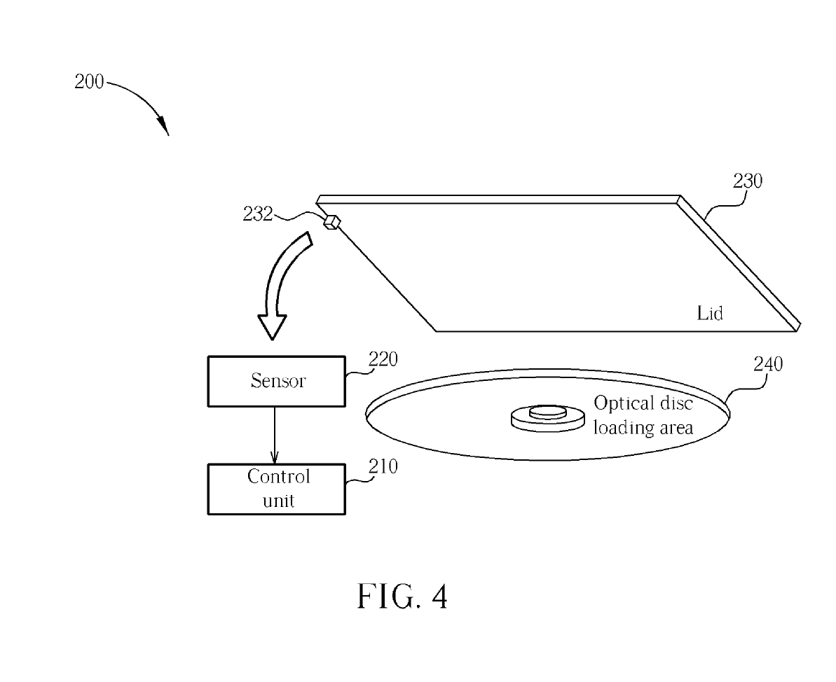

FIG. 4 is a diagram of an optical storage device 200 capable of operating when abnormal according to a second embodiment of this invention. According to one application of this embodiment, the optical storage device 200 can be an optical disc player such as a DVD player. According to another application of this embodiment, the optical storage device 200 can be an optical disc drive applied to computer peripherals/accessories, for example, a DVD drive. The second embodiment is a variation of the first embodiment, where differences between the first and the second embodiments are described as follows.

The optical storage device 200 of this embodiment comprises a control unit 210, a sensor 220, a lid 230, and an optical disc loading area 240, and the lid 230 comprises a contact mechanism 232 corresponding to the sensor 220, where the sensor 220 is a limit switch capable of triggering the start up or stop of a procedure. More particularly, in this embodiment, the sensor 220 is utilized for triggering the start-up or stop of a servo procedure in the normal mode. In addition, the control unit 210 is capable of detecting whether the user determines to enter the abnormal mode. In the abnormal mode, the control unit 210 of this embodiment triggers the start-up or stop of the servo procedure according to a user command such as that mentioned above.

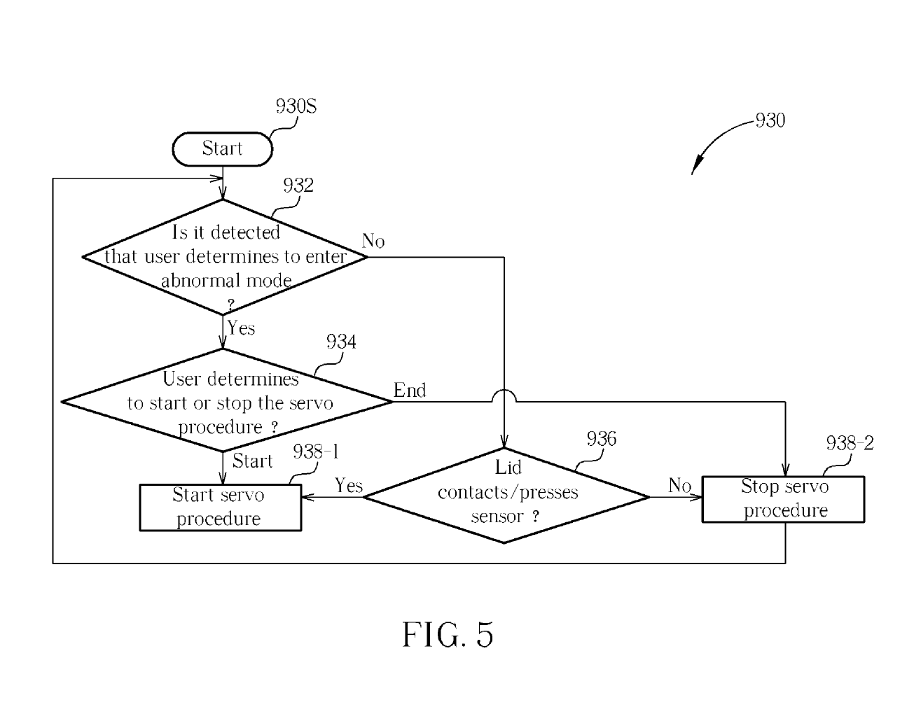

FIG. 5 is a flowchart of a method 930 for controlling an optical storage device to be capable of operating when abnormal according to one embodiment of this invention, where the method 930 can be applied to the embodiment shown in FIG. 4, and described as follows.

In this embodiment, the method 930 represents a workflow after powering on, where Step 934 corresponds to the abnormal mode, and Step 936 corresponds to the normal mode.

In Step 932, the control unit 210 checks whether the user determines to enter the abnormal mode. If the control unit 210 detects that the user determines to enter the abnormal mode, Step 934 is entered in order to control the optical storage device 200 to enter the abnormal mode; otherwise, Step 936 is entered in order to control the optical storage device 200 to enter the normal mode.

In Step 934, the control unit 210 checks whether the user determines to start-up or stop the servo procedure. If the control unit 210 detects that the user determines to start the servo procedure, Step 938-1 is entered in order to start the servo procedure; otherwise, Step 938-2 is entered in order to stop the servo procedure.

According to this embodiment, if the sensor 220 (which is the limit switch here) and the lid 230 are not damaged and operate normally, in the normal mode, the lid 230 triggers the start-up or stop of the servo procedure according to whether the lid 230 contacts/presses the sensor 220. Additionally, once the user finds that the contact mechanism 232 of the lid 230 is damaged so that it cannot trigger the start-up of the servo procedure, or finds that the contact mechanism 232 has fractured and stuck in the sensor 220 so that the stop of the servo procedure cannot be triggered after the optical storage device 200 powers on every time, the user can give a command of entering the abnormal mode through a user interface of the optical storage device 200.

According to the workflow shown in FIG. 5, after the optical storage device 200 powers on every time, the user may input a command of entering the abnormal mode into the control unit 210 through a hotkey provided by the user interface. More particularly, in this embodiment, the user may simultaneously press a plurality of keys of the user interface to input the command of entering the abnormal mode. Thus, the embodiment of this invention provides an urgent protection solution that have not been applied to any product launched on the market, so that in a situation when the sensor 220 or the lid 230 is damaged and operates abnormally while the user urgently needs to use the optical storage device 200, the user will not be forced to cancel his/her important appointments/schedules on the to-do list because of urgent repair of the optical storage device 200. As a result, this invention improves the user's convenience and decision-making power of his/her own time in the situation mentioned above.

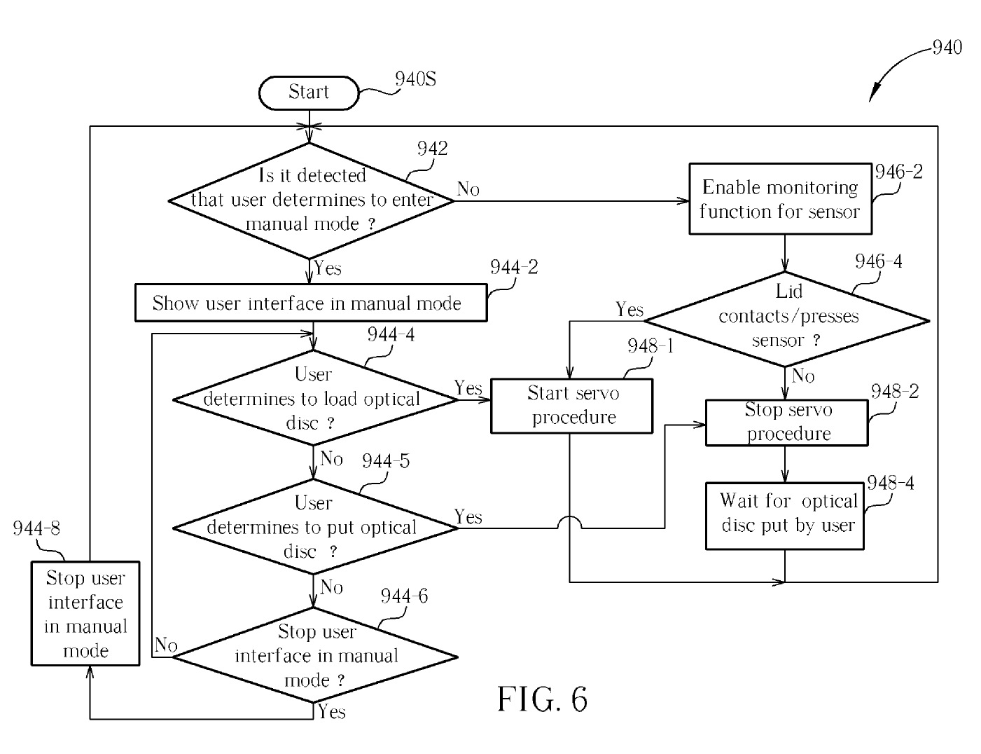

FIG. 6 is a flowchart of a method 940 for controlling an optical storage device to be capable of operating when abnormal according to another embodiment of this invention, this embodiment is a variation of the embodiment shown in FIG. 5, and described as follows.

In this embodiment, the method 940 represents a workflow after powering on, where Steps 944-2, 944-4, 944-5, 944-6 and 944-8 correspond to the abnormal mode, and Steps 946-2 and 946-4 correspond to the normal mode. According to this embodiment, the abnormal mode is referred to as manual mode.

In Step 942, the control unit 210 checks whether the user determines to enter the manual mode. If the control unit 210 detects that the user determines to enter the manual mode, Step 944-2 is entered in order to show the user interface in the manual mode; otherwise, Step 946-2 is entered in order to control the optical storage device 200 to enter the normal mode.

In Step 944-4, the control unit 210 checks whether the user determines to load the optical disc. If the control unit 210 detects that the user determines to load the optical disc, Step 948-1 is entered in order to start the servo procedure; otherwise, Step 944-5 is entered.

In Step 944-5, the control unit 210 checks whether the user determines to put the optical disc. If the control unit 210 detects that the user determines to put the optical disc, Step 948-2 is entered in order to stop the servo procedure; otherwise, Step 944-6 is entered.

In Step 944-6, the control unit 210 checks whether the user determines to stop the user interface in the manual mode. If the control unit 210 detects that the user determines to stop the user interface in the manual mode, Step 944-8 is entered in order to stop the user interface in the manual mode; otherwise, Step 944-4 is re-entered.

The control unit 210 enables the monitoring function for the sensor in Step 946-2, and then detects whether the lid contacts/presses the sensor in step 946-4. If the control unit 210 detects that the lid contacts/presses the sensor, Step 948-1 is entered in order to start the servo procedure; otherwise, Step 948-2 is entered in order to stop the servo procedure. After the servo procedure is stopped, Step 948-4 is entered to wait for the optical disc put by the user.

It should be noted that the workflow shown in FIG. 6 is for illustration purposes only and is not intended as a limitation of the present invention. These steps may be varied according to different embodiments of the present invention.

Those skilled in the art will readily observe that numerous modifications and alterations of the device and method may be made while retaining the teachings of the invention.

What is claimed is:

1. An optical storage device capable of operating when abnormal, comprising:
a control unit for controlling operations of the optical storage device; and
a sensor, coupled to the control unit, wherein in a normal mode of the optical storage device, the control unit triggers the start-up or stop of a procedure through the sensor;
wherein the control unit is capable of controlling the optical storage device to enter an abnormal mode, and triggering the start-up or stop of the procedure in the abnormal mode according to whether the procedure times out or according to a user command.

2. The optical storage device of claim 1, wherein in the normal mode, the control unit determines whether the sensor is abnormal according to whether the procedure times out; if the control unit determines the sensor is abnormal, when the optical storage device performs the procedure next time, the control unit controls the optical storage device to enter the abnormal mode, and triggers the start-up or stop of the procedure according to whether the procedure times out in the abnormal mode; and the optical storage device comprises:
at least one timer, coupled to the control unit, for detecting whether the procedure times out.

3. The optical storage device of claim 2, wherein the control unit utilizes different timer parameters to detect whether the procedure times out in the normal mode and whether the procedure times out in the abnormal mode, respectively.

4. The optical storage device of claim 2, wherein the control unit utilizes the same timer parameter to detect whether the procedure times out in the normal mode and whether the procedure times out in the abnormal mode, respectively.

5. The optical storage device of claim 2, wherein the control unit sets up at least one timer parameter as an initial value for the timer, and the timer is a countdown timer.

6. The optical storage device of claim 2, wherein the sensor is a limit switch, the procedure is a tray in procedure or a tray out procedure, and the optical storage device further comprises:
a tray, for loading an optical disc, wherein if both the limit switch and the tray are not damaged and operate normally, once the tray contacts/presses the limit switch in the normal mode, the limit switch triggers the stop of the tray in procedure or the tray out procedure.

7. The optical storage device of claim 2, wherein after the optical storage device enters the abnormal mode, the control unit controls the optical storage device to disable a monitoring function for a command of the procedure.

8. The optical storage device of claim 1, wherein the control unit is capable of detecting whether a user determines to enter the abnormal mode; when detecting that the user determines to enter the abnormal mode, the control unit controls the optical storage device to enter the abnormal mode; and in the abnormal mode, the control unit triggers the start-up or stop of the procedure according to the user command.

9. The optical storage device of claim 8, wherein the sensor is a limit switch, the procedure is a servo procedure, and the optical storage device further comprises:
a lid, for covering an optical disc loading area, wherein if the limit switch and the lid are not damaged and operate normally, in the normal mode, the lid is capable of triggering the start-up or stop of the servo procedure according to whether the lid contacts/presses the limit switch.

10. The optical storage device of claim 8, wherein if the control unit does not detect that the user determines to enter the abnormal mode, the control unit controls the optical storage device to enter the normal mode.

11. A method for controlling an optical storage device to be capable of operating when abnormal, comprising:
in a normal mode of the optical storage device, triggering the start-up or stop of a procedure through a sensor of the optical storage device; and
selectively controlling the optical storage device to enter an abnormal mode, and triggering the start-up or stop of the procedure in the abnormal mode according to whether the procedure times out or according to a user command.

12. The method of claim 11, wherein the step of selectively controlling the optical storage device to enter the abnormal mode further comprises:
determining whether the sensor is abnormal according to whether the procedure times out in the normal mode; and
if the step of determining whether the sensor is abnormal determines the sensor is abnormal, when the optical storage device performs the procedure next time, controlling the optical storage device to enter the abnormal mode, and triggers the start-up or stop of the procedure according to whether the procedure times out in the abnormal mode.

13. The method of claim 12, further comprising:
utilizing different timer parameters to detect whether the procedure times out in the normal mode and whether the procedure times out in the abnormal mode, respectively.

14. The method of claim 12, further comprising:
utilizing the same timer parameter to detect whether the procedure times out in the normal mode and whether the procedure times out in the abnormal mode, respectively.

15. The method of claim 12, further comprising:
utilizing at least one countdown timer to detect whether the procedure times out; and
setting at least one timer parameter as an initial value of the countdown timer.

16. The method of claim 12, wherein the sensor is a limit switch, the procedure is a tray in procedure or a tray out procedure, and the optical storage device comprises a tray for loading an optical disc; and the step of triggering the start-up or stop of the procedure through the sensor further comprises:
if the limit switch and the tray are not damaged and operate normally, once the tray contacts/presses the limit switch in the normal mode, utilizing the limit switch to trigger the stop of the tray in procedure or the tray out procedure.

17. The method of claim 12, wherein the step of controlling the optical storage device to enter the abnormal mode further comprises:
after the optical storage device enters the abnormal mode, controlling the optical storage device to disable a monitoring function for a command of the procedure.

18. The method of claim 11, further comprising:
detecting whether a user determines to enter the abnormal mode; and
when detecting that the user determines to enter the abnormal mode, controlling the optical storage device to enter the abnormal mode;
wherein the step of triggering the start-up or stop of the procedure in the abnormal mode triggers the start-up or stop of the procedure according to the user command.

19. The method of claim 18, wherein the sensor is a limit switch, the procedure is a servo procedure, and the optical storage device comprises a lid for covering an optical disc loading area; and the step of triggering the start-up or stop of the procedure through the sensor further comprises:
if the limit switch and the lid are not damaged and operate normally, in the normal mode, triggering the start-up or stop of the servo procedure according to whether the lid contacts/presses the limit switch.

20. The method of claim 18, further comprising:
if it is not detected that the user determines to enter the abnormal mode, controlling the optical storage device to enter the normal mode.
